(19) United States
(12) Patent Application Publication
(10) Pub. No.: US 2009/0132716 A1
(43) Pub. Date: May 21, 2009

(54) FAULT-TOLERANT DISTRIBUTED SERVICES METHODS AND SYSTEMS

(76) Inventors: Flavio P. Junqueira, Barcelona (ES); Benjamin C. Reed, Morgan Hill, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/940,723

(22) Filed: Nov. 15, 2007

(51) Int. Cl. G06F 15/16

(52) U.S. Cl. 709/228

(57) ABSTRACT

Methods and apparatuses are provided for use in fault-tolerant distributed services. One method includes establishing a plurality of server processes each associated with different non-overlapping subspace range of a distributed data structure, associating a data object with a corresponding server process based, at least in part, on mapping the data object to the subspace range associated with the server process, and manipulating the data object using the server processes.

### BACKGROUND

1. Field

The subject matter disclosed herein relates to distributed processing, and more particularly to fault-tolerant distributed services methods and systems.

2. Information

Distributed processing techniques may be applied to provide robust computing environments that are readily accessible to other computing platforms and like devices. Systems, such as server farms or clusters, may be configured to provide a service to multiple clients or other like configured devices.

As the size of servicing systems has grown to encompass many servers the size and load of the network services have also grown. It is now common for network services to span multiple servers for availability and performance reasons.

One of the reasons and benefits for providing multiple servers is to allow for a more fault-tolerant computing environment. As the number of devices increases and/or other aspects of the distributed service complexity increases, however, so too may the communications and/or processing requirements increase to support the desired fault tolerance capability.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating an exemplary computing environment system, in accordance with one aspect, having one or more computing platform devices configurable to provide a servicing system that includes a plurality of service instances each of which are capable of handling remotely generated requests.

FIG. 2 is a flow diagram illustrating an exemplary method for providing a servicing system that may be implemented, for example, using one or more devices such as shown in FIG. 1.

FIG. 3 is a block diagram illustrating an exemplary distribution process that may be used to map a data object to a value.

FIG. 4 is a block diagram illustrating an exemplary distribution process that may be used to map a server process to a value.

FIG. 5 is a block diagram illustrating an exemplary servicing system arranged, for example, using the method as shown in FIG. 2.

FIG. 6 is a block diagram illustrating the exemplary servicing system of FIG. 5 further implementing an exemplary consistency protocols within service ensembles.

FIGS. 7A-C are block diagrams illustrating the exemplary servicing system of FIG. 6 adapting to system changes.

### DETAILED DESCRIPTION

Fault-tolerant distributed services often present limited scalability and performance capabilities. Such limitations may occur, for example, due to the complexity of the protocols used to maintain the consistency of server processes composing such services. Such consistency protocols may take several forms. For example, certain consistency protocols may be based on an active replication scheme, in which replica service instances concurrently execute operations (e.g., based on a request submitted by a client device). To provide that the state is consistent across the replica service instances, such a protocol may, for example, include that replica service instances execute the same deterministic operations in the same order.

Alternatively, some consistency protocols may, for example, be based on a passive replication scheme, in which one of the replicated service instances is designated as the lead service instance and as the leader executes operations and propagates the results to its replica service instances.

From the examples above, it may be noted that maintaining consistency tends to imply that the requisite communication overhead may increase along with the number of service instances. For example, a protocol may specify at least one round of messages from one lead and/or replica service instance to all the others for each operation.

Unfortunately, adding more server processes may not increase the capacity of the system for certain operations. To mitigate this problem, one possible technique may be to split a pool of server processes into clusters, and have each cluster process operations for disjoint parts of the state space. The system state may be, for example, a tree of directories and files in a file system, and such a split may be into sub-trees of the file system tree. Unfortunately, with such a split, the number of faults that may be tolerated may actually be reduced since each subspace is provided for by only a subset of the server processes. Further, such a split may produce an uneven load across the clusters. For example, when a state is split into sub-trees in a file system some of the sub-trees may contain more files and directories as the system progresses, which may result in uneven loading across the server processes.

Methods and systems are presented herein, which may allow for a system state to be divided into subspaces for scalability purposes while also or otherwise providing for increased levels of fault-tolerance for each subspace.

For example, as described in greater detail in subsequent sections, methods and systems may be employed to organize server processes or the like based on distributed data structure defining a linear space, such as, for example, a distributed hash table (DHT) or the like, such that “service ensembles” may be formed based on a distributed data structure. By way of example but not limitation, in certain implementations, service ensembles may be formed (e.g., based on the “proximity” or some other scheme) using two or more server processes. Consistency protocols may then be used within each of such service ensembles. Such service ensembles may, for example, reduce the communication and/or processing overhead that might otherwise be experienced.

Moreover, by distributing data objects and sometimes even server processes to such subspaces and/or service ensembles, for example, a balanced loading across the servicing system may be realized. Here for example, a distributed data structure such as a DHT may be used to map identifiers to values (e.g., integers) in the range of a hash function. In certain implementations, for example, the range of the hash function may form a circular space. Such a value may be assigned to each server process. Each server process may, for example, be assigned to and/or otherwise responsible for a subspace range portion of linear space. This subspace range may, for example, include other values around or otherwise associated with the value of the server process.

The state of the system may include data objects, for example, wherein the data objects may be arbitrary data structures that may have a set of operations associated therewith. Such data objects may each map to a unique value of the linear space. Client or other like processes/devices may, for example, submit requests, queries or other like operations associated with such data objects through the server process that is responsible for the subspace range that includes the value of the data object.

To establish or otherwise modify a subspace range, in certain implementations a server process may contact the neighbor server processes (e.g., that are adjacent in the linear space) and the server processes may determine their subspace ranges according to some strategy. Service ensembles may also be established in a similar manner.

The service ensembles may, for example, be configured with some overlap and may expand, retract, or split as needed to support changes in the servicing system. The level of fault tolerance capability provided by a service ensemble may be adjusted, for example, based on the number of server processes included in the service ensemble. Further, the number of server processes in service ensembles may vary overtime and/or across the servicing system.

In certain implementations, the servicing system may include an implementation of one or more underlying and/or overlying (logical or virtual) networks or other like communications protocols and/or schemes, which allow for server processes to communicate together and/or with other processes (local and/or remote), handle requests or queries, access data objects and the like, dynamically join and/or leave the servicing system or one or more service ensembles therein. Such may include, by way of example but not limitation, a DHT-based network/routing scheme or the like.

In accordance with certain implementations, examples of which are described in more detail in subsequent sections, a replication scheme may include the presence of a lead service instance and at least one replica service instance for each of a plurality of service ensembles. With such a leader-based replication scheme, for example, the lead service instance may be adapted to determine an order of the requests associated with its subspace range.

Thus, in certain implementations, a lead service instance may be assigned or otherwise designated as a leader based on its value and subspace range. To provide fault tolerance, the leader-based replication scheme may, for example, be adapted to guarantee that a leader remains substantially available. To recover from or mask a leader failure and provide that a leader remains available, the replication scheme may reassign the data objects mapped to the failed leader's subspace range to one or more neighboring (expanded) subspace ranges each with its own lead service instance and a replica service instance associated with the failed lead service instance. As such, the replication scheme may be adapted to provide protocols that require that all of the replica service instances receive the same set of requests and in the same order, to allow for service instance failures to be masked or otherwise handled.

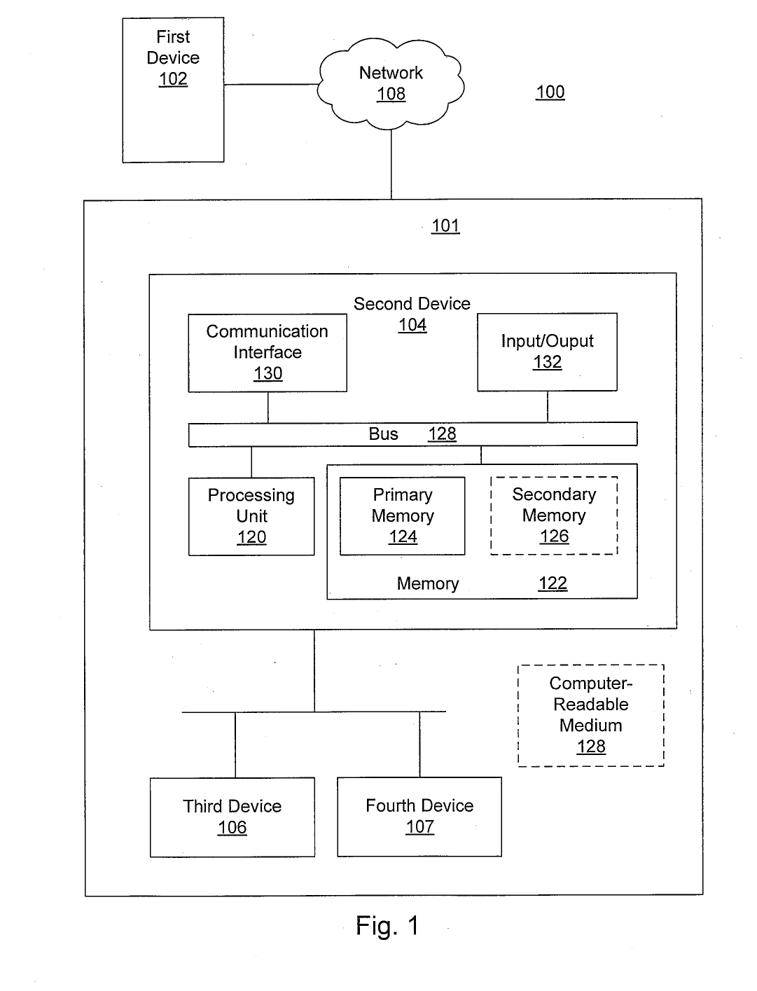

With this introduction in mind, attention is now drawn to FIG. 1, which is a block diagram illustrating an exemplary implementation of a computing environment system 100 which may, for example, include a servicing system 101 that is operatively coupled to a first device 102, here, e.g., through a network 108. In certain implementations, for example, first device 102 may include a client device and servicing system 101 may include one or more server devices, each of which may provide one or more server processes.

As illustrated, within servicing system 101 there may be one or more computing system platforms. For example, servicing system 101 may include a second device 104, a third device 106 and a fourth device 107, each of which are further operatively coupled together. In this example, second device 104 may be the same type of device or a different type of device than third device 106 and/or fourth device 107. With this in mind, in the examples that follow, only second device 104 is described in greater detail in accordance with certain exemplary implementations.

Further, it should be understood that first device 102, second device 104, third device 106, and fourth device 107, as shown in FIG. 1, are each representative of any device, appliance or machine that may be configurable to exchange data over network 108. By way of example but not limitation, any of these devices may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet based service provider/system, a portal and/or search engine service provider/system, a wireless communication service provider/system; and/or any combination thereof.

Similarly, network 108, as shown in FIG. 1, is representative of one or more communication links, processes, and/or resources configurable to support the exchange of data between at least two of first device 102, second device 104, third device 106, and fourth device 107. By way of example but not limitation, network 108 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 100, and the processes and methods as further described herein, may be implemented using or otherwise include hardware, firmware, software, or any combination thereof.

Thus, by way of example but not limitation, second device 104 may include at least one processing unit 120 that is operatively coupled to a memory 122 through a bus 128.

Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 128. Computer-readable medium 128 may include, for example, any medium that can carry and/or make accessible data, code and/or instructions for one or more of the devices in system 100.

Second device 104 may include, for example, a communication interface 130 that provides for or otherwise supports the operative coupling of second device 104 to at least network 108. By way of example but not limitation, communication interface 130 may include a network interface device or card, a modem, a router, a switch, a transceiver, and the like.

Second device 104 may include, for example, an input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, mouse, trackball, touch screen, data port, etc.

With regard to system 100, in certain implementations first device 102 may be configurable, for example, to generate and transmit a request associated with a procedure or other like operation that servicing system 101 may provide. For example, one such request may take the form of or be adapted from an RPC protocol 103 illustrated as being operatively associated with servicing system 101 and first device 102.

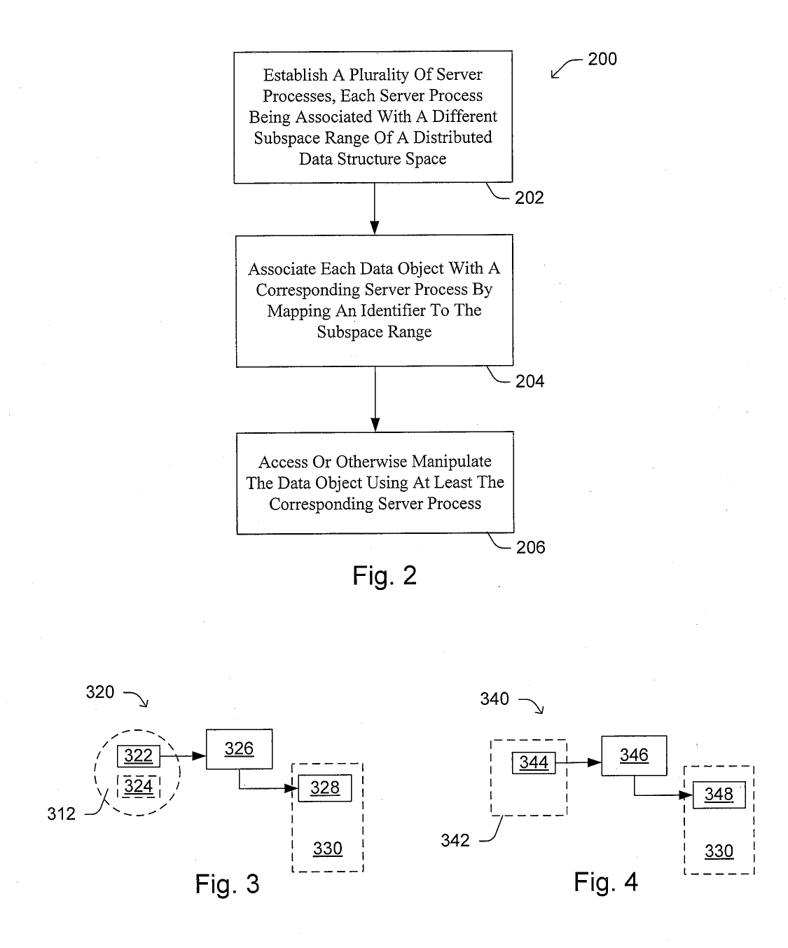

Reference is now made to FIG. 2, which is a flow diagram illustrating an exemplary method 200 for establishing a servicing system that may be implemented, for example, using one or more devices such as shown in FIG. 1.

In 202, a plurality of server processes are established, for example, one or more devices. Each of the server processes may be associated with a different (i.e., non-overlapping) subspace range of a distributed data structure space. In 204, data objects may be associated with corresponding server processes, for example, by mapping an identifier associated with a data object to one of the different subspace ranges of the distributed data structure space. In 206, a server process may access or otherwise manipulate data objects associated therewith in 204.

Method 200 is described is greater detail below with further reference to FIGS. 3-7.

FIG. 3 is a block diagram illustrating an exemplary distribution process 320 that may be used to map a data object 312 to a value 328 of space 300 (e.g., represented here by a DHT 330). In this example, data object 312 is illustrated as having associated with it at least a substantially unique identifier 322. Data object 312 may also include or be associated with other related data and/or instructions 324 that may be accessed or otherwise manipulated by a server process. Unique identifier 322 may include, for example, any type of data that identifies the data object, and of which at least a portion may be processed by one or more functions 326 to produce value 328. By way of example but not limitation, in certain implementations unique identifier 322 may include one or more of a uniform resource locator (URL), a file name, a hierarchical node name, and/or other like identifying data.

Similarly, FIG. 4 is a block diagram illustrating an exemplary distribution process 340 that may be used to map a server process 342 to a value 348 of space 300 (e.g., represented here by a DHT 330). In this example, server process 342 is illustrated as having associated with it at least a substantially unique identifier 344. Unique identifier 344 may include, for example, any type of data that identifies the server process, and of which at least a portion may be processed by one or more functions 346 to produce value 348. In certain implementations, for example, functions 326 and 346 may include the same function (e.g., a hash function). In other implementations, functions 326 and 346 may include the different function and or processes. By way of example but not limitation, in certain implementations unique identifier 344 may include one or more of a uniform resource locator (URL), network address, and/or other like identifying data.

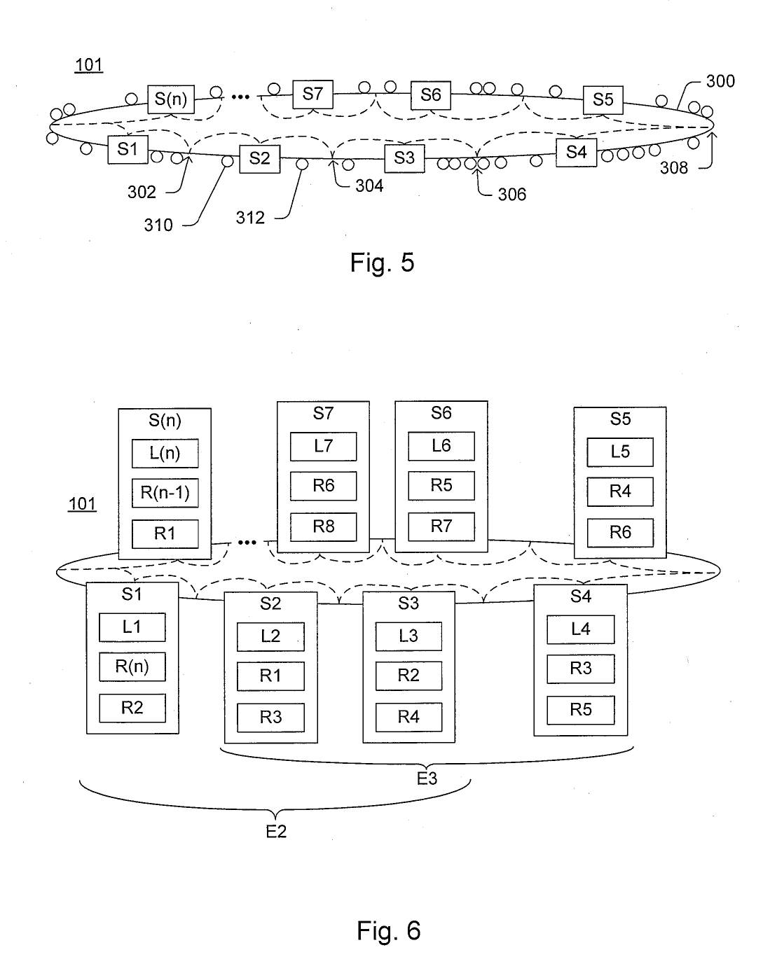

FIG. 5 is a block diagram visually representing and thus illustrating certain features of an exemplary servicing system 101 arranged, for example, using method 200. By way of example but not limitation, FIG. 5 shows an exemplary graphical view of a linear space 300 that in this illustration is represented by a line that curves around to present a closed, circular space. In certain implementations, for example, space 300 may include or otherwise be defined using a distributed data structure. Space 300 may include a plurality of values or the like. Such values may, for example, be generated using one or more functions. In certain implementations, for example, a hash function or other like function may be used to convert input data into values of space 300. In certain implementations, for example, space 300 may be established or otherwise associated with a DHT.

As shown in FIG. 5, a plurality of server processes (shown here as blocks with the letter “S” followed by an integer numerical reference) may be distributed or otherwise arranged within the space, for example, at particular values therein. In certain implementations, the server processes may be arranged randomly, pseudo randomly or specifically arranged according to some other scheme or plan within space 300. A function may be used, for example as in FIG. 4, to distribute server processes. In this example, server processes S1 through S(n) are shown arranged about space 300 in numerical order per their numerical reference (e.g., S1, S2, S3, S4, S5, S6, S7, . . . , S(n)).

In FIG. 5 dashed lines leading outwardly from each of the server processes illustrate that each of the server processes is associated with a different subspace range of space 300. For example, a subspace range for server process S2 extends between arrow 302 and arrow 304 as illustrated by a first dashed line leading out to arrow 302 located along space 300 between server processes S1 and S2, and a second dashed line leading out to arrow 304 located along space 300 between server process S2 and server process S3. Here, for example, arrow 302 and arrow 304 may be associated with specific boundaries between subspaces. By way of example but not limitation, arrow 302 may point to a first value of “23456” and arrow 304 may point to a second value “45678” such that the subspace range for server process S2 may start at value “23456” and end at the value before the second value, namely “45677” (e.g., 45678−1=45677). Similarly, other dashed lines show a subspace range for server process S3 between arrow 304 and arrow 306. Where, for example, to continue the example assume that arrow 306 points to a third value “78901”, as such the subspace range for server process S3 may start at “45678” and end at the value before the third value, namely “78900” (e.g., 78901−1=78900). Also, shown in similar manner is a subspace range for server process S4 between arrow 306 and arrow 308.

Also as shown in FIG. 5, a plurality of data objects (represented by the small circles on the line of space 300) may be mapped to space 300 using a distribution or other like scheme or technique. Here, for simplification only a few data objects are shown and only two have reference numbers, e.g., 310 and 312. In accordance with certain implementations, for example, it may be desirable to have the data objects mapped such that each data object has a unique value of space 300. Thus, if a function, such as, for example, a hash function is used to map unique identifiers of the data objects to the space, then collisions may be substantially avoided.

As illustrated in FIG. 5 all of the data objects and server processes in this example may be associated with unique values on space 300 and as such associated and/or assigned to specific subspace ranges. Thus, for example, data objects 310 and 312 are illustrated as being between arrow 302 and arrow 304 and as such are within the subspace range for server process S2. As such, the server processes of server process S2 may access or otherwise manipulate data objects 310 and 312.

Reference is now made to FIG. 6, which is similar to FIG. 5 and further illustrates some exemplary features of server processes S1-S(n) (e.g., S#) in accordance with an exemplary consistency scheme. Here, each of the server processes provides a lead service instance (L#) and at least two replica service instances (R#). Here, several service ensembles are formed each with three neighboring server processes. For example, as shown, server processes S1, S2 and S3 form service ensemble E2. Similarly, as shown, server processes S2, S3 and S4 form service ensemble E3.

With reference to service ensemble E2, here server process S2 may provide a lead service instance (L2) which may be associated with and assigned to data objects (not shown) within the subspace range of server process S2. Lead service instance L2 may be supported with fault tolerant replication processes such as, for example, a replica service instance R2 provided by server process S1 and a replica service instance R2 provided by server process S3.

With reference to service ensemble E3, as shown server process S3 may provide a lead service instance (L3) which may be associated with and assigned to data objects (not shown) within the subspace range of server process S3. Lead service instance L3 may be supported with fault tolerant replication processes such as, for example, a replica service instance R3 provided by server process S2 and a replica service instance R2 provided by server process S4.

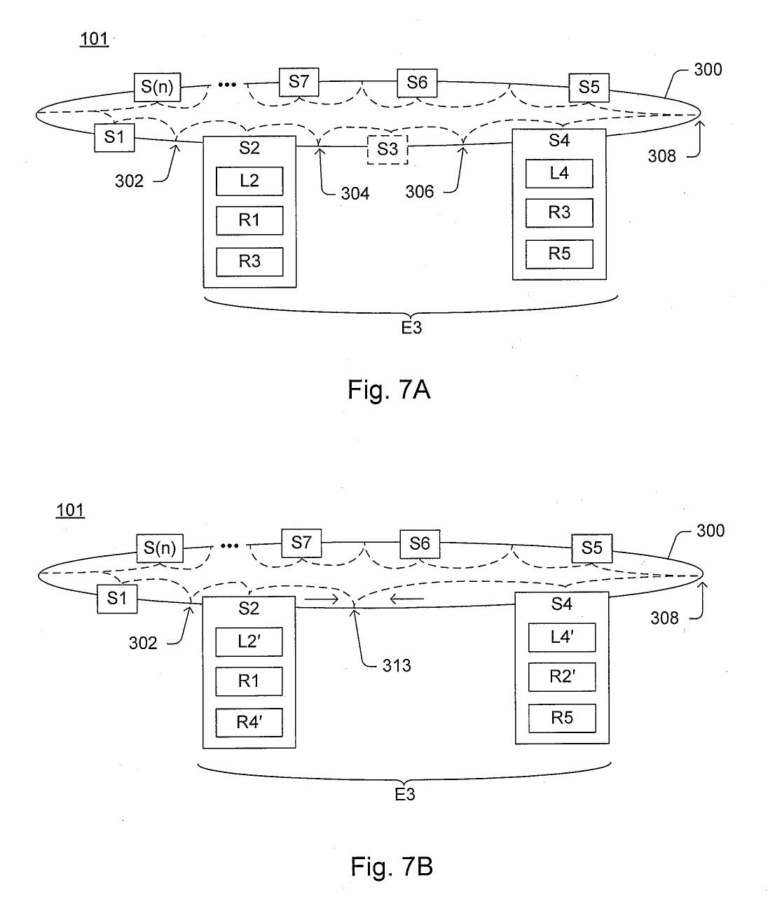

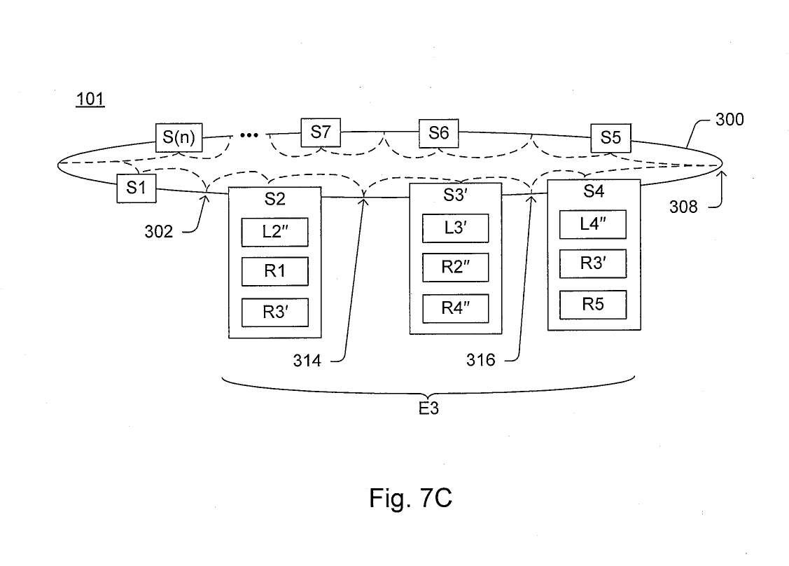

FIG. 7A-C are block diagrams illustrating an exemplary servicing system 101 with the service processes of service ensemble E3, for example as shown in FIG. 6, adapting to certain exemplary system changes.

In FIG. 7A, for example, server process S3 is shown using a dashed line block to illustrate that server process S3 has changed its operative state from active to inactive (e.g., server process S3 may have intentionally or unintentionally stopped operating). As such the subspace range of server process S3 shown between arrow 304 and arrow 306 is no longer associated with the server process S3.

As such, for example, one or more of the other server processes within the service ensemble E3 (here, server process S2 and/or server process S4) which may each be providing a replica service instance R3 may be adapted to identify the absence of server process S3 and take over responsibility for subspace range of server process S3 between arrow 304 and arrow 306 now that the lead service instance L3 of server process S3 is no longer available.

In FIG. 7B, for example, the subspace range of server process S3 between arrow 304 and arrow 306 of FIG. 7A has been consumed by the expansion of one or both of the subspace ranges of server process S2 and/or server process S4. Here, for example, the subspace range of server process S2 now extends between arrow 304 and arrow 313 and the subspace range of server process S4 now extends between arrow 313 and arrow 308. Also, as illustrated, server process S2 has adapted to provide a lead service instance L2′ to service the expanded subspace range of server process S2 and to provide a new replica service instance R4′ for its new neighbor server process S4. Similarly, as illustrated, server process S4 has adapted to provide a lead service instance L4′ to service the expanded subspace range of server process S4 and to provide a new replica service instance R2′ for its new neighbor server process S2. The expansion and adaptation undertaken by one or both of server process S2 and/or server process S4 to account for the loss of server process S3, may be negotiated between server processes S2 and S4. Here, in this example, since both server processes S2 and S4 have replica service instances R3, one or both may be aware of the system state of the data objects previously associated with server process S3 and hence the fault tolerance protocols or other processes may be followed accordingly to eliminate or otherwise seek to reduce or avoid downtime of service associated with the data objects that were associated with the subspace range of server process S3.

In FIG. 7C, for example, it is assumed that a new server process S3′ is to join service 101 here as illustrated (logically on space 300) between server processes S2 and S4. To accomplish this, for example, server processes S2 and S4 may negotiate together and/or individually with server process S3′ or otherwise be instructed in some manner to retract one or both of their respective subspace ranges to establish a new subspace range for server process S3′, which is shown in FIG. 7C as mapping to a value somewhere between arrows 314 and 316.

As further illustrated, server process S2 has adapted to provide a lead service instance L2″ to service the retracted subspace range of server process S2 and to provide a new replica service instance R3′ for its new neighbor server process S3′. Similarly, as illustrated, server process S4 has adapted to provide a lead service instance L4″ to service the retracted subspace range of server process S4 and to provide a new replica service instance R3′ for its new neighbor server process S3′. Also, as illustrated, server process S3′ may provide a lead service instance L3′ to service the new subspace range of server process S3′ and to provide a new replica service instance R2″ for its new neighbor server process S2 and a new replica service instance R4″ for its other new neighbor server process S4.

With these examples in mind and returning to FIG. 2, by way of further example but not limitation, per method 200, 202 may include establishing a server processes using at least one computing platform, wherein each server process is associated with a different subspace range of a distributed data structure that defines or otherwise includes a linear space. The linear space may be closed, for example, circular or the like. The linear space may include sequential or otherwise linearly associated values, such as, for example, integer values or the like. The linear space may, for example, include a closed range of values that are established by or otherwise associated with a hash function or other like function. The distributed data structure may include, for example, a distributed hash table or the like.

In certain implementations, for example, 202 may include determining a value within the linear space for each server process and determining the subspace range associated with the server process based, at least in part, on the determined value for the server process. For example, a subspace range may be determined to include the value determined for the server process and a range of values associated therewith. For example, a subspace range may be determined using a formula or function that takes into consideration the value determined for the server process. In certain implementations, 202 may include determining a value within the linear space for a server process by processing at least a portion of a unique identifier associated with the server process using a hash function or the like. In other implementations, 202 may include predetermining a value within the linear space for a server process based on certain factors associated with the servicing system, such as, for example, performance factors, location factors, communication factors, security factors, or other like factors or strategies.

By way of example but not limitation, method 200 may include, in 204 associating a data object with a corresponding server process based, at least in part, on mapping the data object to the subspace range that is associated with the server process.

By way of example but not limitation, in certain implementations 204 may include determining a value within the linear space for the data object based, at least in part, on at least a portion of a unique identifier associated with the data object using a function, such as a hash function or the like.

By way of example but not limitation, method 200 may include, in 206 establishing at least one service ensemble that includes at least two server processes, wherein each of the server processes provides at least one replicated service instance of a service instance provided by the other. As illustrated in FIG. 6, for example, a service ensemble E3 may include a server process S2 providing a lead service instance L2 that is associated with a first subspace range, and a server process S3 providing a lead service instance L3 that is associated with a second subspace range. Here also, for example, the first server process S2 may provide a replica service instance R3 that is associated with the lead service instance L3 and the server process S3 may provide a replica service instance R2 that is associated with the lead service instance L2.

Continuing with the leader based example above and referring to FIG. 6, the exemplary service ensemble E3 may also include server process S4 which may provide a lead service instance L4 associated with a third subspace range. As shown, server process S3 may provide a replica service instance R4 associated with the lead service instance L4 and the third server process S4 may provide at least an additional replica service instance R3 associated with the lead service instance L3.

In method 200, 202 may, for example, include determining that a change associated with an operative state of a server process and/or a service instance provided thereby has changed in some manner to initiate a fault recovery. For example, a server process or service instance provided thereby may intentionally or unintentionally stop operating and the system and/or service ensemble needs to recover. Consider, for example, as illustrated in FIGS. 7A-C that the lead service instance L3 has stopped operating, e.g., as a result of a failed server process S3. One or both of server processes S2 and/or S4 may recognize the failure of L3 and/or server process S3, for example, due to loss of communication and/or other signals therewith.

To recover from the failure, 202 in method 200 may include expanding at least one subspace range associated with either server process S2 and/or server process S4, which as illustrated in FIG. 7B results in the complete consumption of the subspace range previously associated with server process S3. Thus, for example, 202 in method 200 may include adapting the lead service instances L2 of server process S2 and/or L4 of server process S4, as needed, to accommodate the expansion of their respective subspace ranges as illustrated in FIG. 7B and which results in adapted service lead service instances L2′ and L4′.

Such adaptation may, for example, be based on the replica service instance R3 provided by server processes S2 and S4 when server process S3 failed. In certain implementations, for example, such adaptation may include a negotiation or other like determining process by one or between both server processes S2 and S4 to determine each server processes' consumption of the subspace range previously associated with server process S3. Such negotiation or other like determining process may include, for example, a consideration of various performance or other factors associated with the existing service instances and/or subspace ranges for one or both of server processes S2 and/or S4. For example, server process S2 may be determined based on certain factors or considerations to be more capable of consuming more of the subspace range of server process S3 than would be server process S4. Indeed, in certain implementations, it may be determined that one of the server processes S2 or S4 should consume as much as 100% of the subspace range previously associated with failed server process S3.

In other implementations, rather than consider such factors or other like considerations, server processes S2 and S4 may be configured to divide the subspace range previously associated with failed server process S3 based on some predetermined formula. For example, in certain implementations, server processes S2 and S4 may be configured to simply divide the subspace range previously associated with failed server process S3 in half such that each consumes 50%.

In method 200, 202 may, for example, also include adapting the server processes S2 and S4, as needed to provide new or updated replication of certain service instances as a result of server process S3 having failed and server processes S2 and S4 becoming adjacent neighbors within system 101 and/or within service ensemble E3. Thus, in this example server process S2 may provide a new replica service instance R4′ associated with the adapted lead service instance L4′; and server process S4 may provide a new replica service instance R2′ associated with the adapted lead service instance L2′.

In method 200, 202 may also allow of the retraction of subspace ranges, for example, as may be needed to add or otherwise introduce a new server process into system 101 and/or an ensemble. An example is illustrated in FIG. 7C, wherein following the adaptation of FIG. 7B, a new server process S3′ is added to service ensemble E3 between server processes S2 and S4.

Thus, in method 200, 202 may include creating a new subspace range through retraction of one or more existing subspace ranges. Here, as shown in FIG. 7C, the subspace ranges for both server processes S2 and S4 have been retracted to create subspace range for server process S3′. In method 200, 202 may further include adapting the lead service instances L2′ and L4′ as needed to accommodate the respective retraction of their subspaces. In FIG. 7C the adapted lead service instances are shown as L2″ and L4″. A new lead service instance L3′ is provided by server process S3′.

To reconfigure the replication capability of ensemble E3, 202 of method 200 may further include, with server process S3′, providing a replica service instance R2″ associated with the lead service instance L2″ and a replica service instance R4″ associated with the lead service instance L4″. Additionally, 202 may include providing replica service instances R3′ by both server process S2 and server process S4.

The exemplary systems and methods described herein may allow for increased capacity in a service system. For example, as more server processes added to the servicing system, additional ensembles may be created. Because each ensemble is associated with the traffic for a given subset of data objects, more ensembles may allow for additional and smaller subspace ranges, and consequently the servicing system may support more requests per data object. Such exemplary systems and methods may allow for increased scalability

The exemplary systems and methods described herein may allow for automated failure recovery. As described in the preceding examples, the servicing system may tolerate crash failures of all but a minimum quorum of server processes within a service ensemble. When a server process fails, new server processes may join the affected service ensemble to return the service ensemble to the pre-failure state.

The exemplary systems and methods described herein may allow for a more evenly distributed load. By way of example but not limitation, a load my be more evenly distributed by use of a hash function of a DHT to randomly map data objects to values in the space in a significantly collision-free manner, and/or such that the number of data objects per ensemble and/or subspace range is more evenly distributed across the space.

The exemplary systems and methods described herein may allow for flexible load balancing. For example, the number of server processes in a given interval may be either automatically or manually assigned. If, for example, server processes may be manually assigned to certain subspace ranges, to add more capacity to a given service ensemble or some other region of the space, then additional server processes may join and be added as needed.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
establishing a plurality of server processes using at least one computing platform, each server process being associated with a different subspace range of a distributed data structure defining a linear space;
associating a data object with a corresponding one of said plurality of server processes based, at least in part, on mapping said data object to said subspace range associated with said one of said plurality of server processes; and
manipulating said data object using said corresponding one of said plurality of server processes.

2. The method as recited in claim 1, further comprising:
establishing at least one service ensemble comprising at least two server processes each one of said at least two server processes being adapted to provide at least one replicated service instance of a service instance provided by the other one of said at least two server processes.

3. The method as recited in claim 2, wherein said at least two server processes, include:
a first server process providing a lead first-service instance associated with a first subspace range; and
a second server process providing a lead second-service instance associated with a second subspace range, and
wherein said first server process further provides at least a replica second-service instance associated with said lead second-service instance and said second server process further provides at least a replica first-service instance associated with said lead first-service instance.

4. The method as recited in claim 3, wherein said service ensemble further comprises at least a third server process providing a lead third-service instance associated with a third subspace range, and wherein said second server process further provides a replica third-service instance associated with said lead third-service instance and said third server process provides at least an additional replica second-service instance associated with said lead second-service instance, and further comprising:
with said computing platform, determining a change associated with an operative state of said lead second-service instance and in response:
expanding at least one subspace range selected from among said first and third subspace ranges to consume said second subspace range;
adapting said lead first-service instance as needed to accommodate said expansion of said first subspace based at least in part, on said replica second-service instance;
adapting said lead third-service instance as needed to accommodate said expansion of said third subspace based at least in part, on said additional replica second-service instance;
with said first server process providing a new replica third-service instance associated with said adapted lead third-service instance; and
with said third server process providing a new replica first-service instance associated with said adapted lead first-service instance.

5. The method as recited in claim 3, further comprising:
with at least said one computing platform, adding a third server process to said service ensemble by:
retracting at least one subspace range selected from among said first and second subspace ranges to create a third subspace range;
adapting said lead first-service instance as needed to accommodate said retraction of said first subspace;
adapting said lead second-service instance as needed to accommodate said retraction of said second subspace;
with said third server process providing a lead third-service instance associated with said third subspace range and at least an additional replica first-service instance associated with said lead first-service instance and an additional replica second-service instance associated with said lead second-service instance;
with said first server process providing a replica third-service instance associated with said lead third-service instance; and
with said second server process providing an additional replica third-service instance associated with said lead third-service instance.

6. The method as recited in claim 1, wherein mapping said data object comprises:
determining a value within said linear space based, at least in part, on at least a portion of a unique identifier associated with said data object.

7. The method as recited in claim 6, wherein determining said value within said linear space comprises:
processing at least said portion of said unique identifier using a hash function.

8. The method as recited in claim 1, wherein said linear space comprises a closed range of values established by a hash function.

9. The method as recited in claim 1, wherein said distributed data structure comprises a distributed hash table.

10. The method as recited in claim 1, wherein establishing said plurality of server processes comprises, for each server process:
determining a value within said linear space for said server process; and
determining said subspace range associated with said server process based, at least in part, on said determined value for said server process.

11. The method as recited in claim 10, wherein determining said value within said linear space comprises:
processing at least a portion of a unique identifier associated with said server process using a hash function.

12. A system comprising:
at least one computing platform having memory and at least one processing unit operatively coupled to said memory, wherein said memory is adapted to store a plurality of data objects and said at least one processing unit is adapted to:
provide a plurality of server processes, each server process being assigned to a different subspace range of linear space defined by a distributed data structure;
for each data object in said plurality of data objects, determining a value within said distributed data structure space for said data object; said value associating said data object with a specific subspace range; and
manipulate at least one data object associated with said specific subspace range with said server process assigned to said specific subspace range.

13. The system as recited in claim 12, wherein said at least one processing unit is adapted to:
establish at least one service ensemble comprising at least two server processes each one of said at least two server processes being adapted to provide at least one replicated service instance of a service instance provided by the other one of said at least two server processes.

14. The system as recited in claim 12, wherein said at least one processing unit is adapted to generate said value by processing at least a portion of a unique identifier associated with said data object using a hash function.

15. The system as recited in claim 12, wherein said distributed data structure comprises a distributed hash table.

16. A computer program product, comprising computer-readable medium comprising instructions for causing at least one processing unit to:
provide a plurality of server processes, each server process being assigned to a different subspace range of linear space defined by a distributed data structure;
for each data object in said plurality of data objects, determining a value within said distributed data structure space for said data object; said value associating said data object with a specific subspace range; and
manipulate at least one data object associated with said specific subspace range with said server process assigned to said specific subspace range.

17. The computer program product as recited in claim 16, wherein said at least one processing unit is adapted to:
establish at least one service ensemble comprising at least two server processes each one of said at least two server processes being adapted to provide at least one replicated service instance of a service instance provided by the other one of said at least two server processes.

18. The computer program product as recited in claim 16, further comprising instructions for causing said at least one processing unit to:
generate said value by processing at least a portion of a unique identifier associated with said data object using a hash function.

19. The computer program product as recited in claim 16, wherein said distributed data structure comprises a distributed hash table.

20. The computer program product as recited in claim 16, wherein said linear space comprises a closed range of values established by a hash function.
